(19) United States
(12) Patent Application Publication
(10) Pub. No.: US 2005/0278642 A1
(43) Pub. Date: Dec. 15, 2005

(54) Method and system for controlling a collaborative computing environment

(76) Inventors: Nelson Liang An Chang, San Jose, CA (US); I-Jong Lin, Half Moon Bay, CA (US)

Correspondence Address: HEWLETT-PACKARD COMPANY;Intellectual Property Administration, P.O. Box 272400, Fort Collins, CO, 80527-2400, US

(21) Appl. No.: 10/866,354

(22) Filed: Jun. 10, 2004

(51) Int. Cl. G06F 17/00

(52) U.S. Cl. 715/751

(57) ABSTRACT

A method and system for controlling a collaborative computing environment to accommodate client devices with different operational characteristics, which includes creating a collaborative environment with a global state data structure that maintains the state of one or more environment elements of the collaborative environment, collecting operational characteristics associated with one or more client devices, modifying the manner of rendering environment elements on each of the one or more client devices according to the operational characteristics of the one or more client devices, and enabling interactions between client devices and environment elements according to the environment elements' current state in the global state data structure.

### BACKGROUND

The present invention relates to collaborative environments among groups of client devices. There are a variety of collaborative environments in common use. These range from multi-player games, to collaborative workspaces and to e-commerce transactions. These environments allow client devices to interact in a common graphical environment. Users can perform a variety of tasks, including manipulating their view, communicating with other users, manipulating objects, and so forth.

It remains difficult to create effective collaborative environments for client devices with widely varying operational characteristics. These differences directly impact the ability for client devices with different processing, storage and throughput capabilities to actively interact within the collaborative environment. These clients can range from workstations to desktop PCs to PDAs and even to cellphones. More often than not, the diverse clients in conventional collaborative systems have even more limited rendering capabilities and/or memory. In general, the clients can also be on either a wired or wireless network, have large or small memories/cache, and even different operating systems.

For example, multiplayer games are one form of a rich interactive collaborative environment designed for computing among heterogeneous computer systems. In most cases, each client is required to maintain a local copy of the entire game state and relevant data. Updates to the multiplayer environment or “world” along with characters are transmitted to a central server and then onto each client. Unfortunately, changes in the multiplayer gaming environment also require large updates of data on every client. If the system does not appropriately compensate for differences in the clients' throughput and processing capabilities, it is possible for a client device's local data to be out of sync with the game state. This directly impacts the interactivity for the affected user and reduces the overall collaborative nature of the gaming or other similar type of application.

### BRIEF DESCRIPTION OF THE DRAWINGS

The present invention is illustrated by way of example and not limitation in the figures of the accompanying drawings in which:

FIG. 1A is a block diagram showing three devices with differing operational characteristics participating in a collaborative environment using one embodiment of the present invention.

FIG. 1B is a block diagram illustrating example devices that might participate in a collaborative environment and indicating the corresponding bandwidth, processing power, memory, and screen size operational characteristics in accordance with one implementation of the present invention.

FIG. 2 is a flowchart showing the controlling of rendering environment elements of a collaborative environment in accordance with one embodiment of the present invention.

FIG. 3 is a flowchart for controlling the rendering of environment elements for client devices participating in a collaborative environment in accordance with one embodiment of the present invention.

FIG. 4 is a schematic showing the software and hardware components in a device taking part in a collaborative environment in accordance with one embodiment of the present invention.

### SUMMARY OF THE INVENTION

One aspect of the present invention describes a method for controlling a collaborative computing environment to accommodate client devices with different operational characteristics. The controlling operations includes creating a collaborative environment with a global state data structure that maintains the state of one or more environment elements of the collaborative environment, collecting operational characteristics associated with one or more client devices, modifying the manner of rendering environment elements on each of the one or more client devices according to the operational characteristics of the one or more client devices, and enabling interactions between client devices and environment elements according to the environment elements' current state in the global state data structure.

Another aspect of the present invention describes a system for controlling a collaborative computing environment. The system is composed of one or more servers, one or more client devices, a network connecting the server with the client devices, a collaborative environment with a global state data structure that maintains the state of one or more environment elements of the collaborative environment, a module for collecting operational characteristics that describe the one or more client devices, a module for controlling the manner of rendering the environment elements for the one or more client devices based on their operational characteristics, and a module for enabling interactions between client devices and environment elements according to the environment elements' current state in the global state data structure.

### DETAILED DESCRIPTION

In accordance with the embodiments presented, a system and method are provided for controlling an interactive collaborative environment. The method is suitable for enhancing environments such as interactive computer games, e-commerce collaborative environments, collaborative work environments, and teleconferencing environments. These environments are often rendered in two dimensions (2-D) or three dimensions (3-D) to enhance the user experience and allow the users to interact on many different dimensions or levels.

Thanks to the ubiquity of computer systems, environments making use of interactivity and collaboration are flourishing. However, the heterogeneity of these computer systems has also posed challenges for such interactivity. The description below demonstrates methods and systems for altering or optimizing the running of such environments.

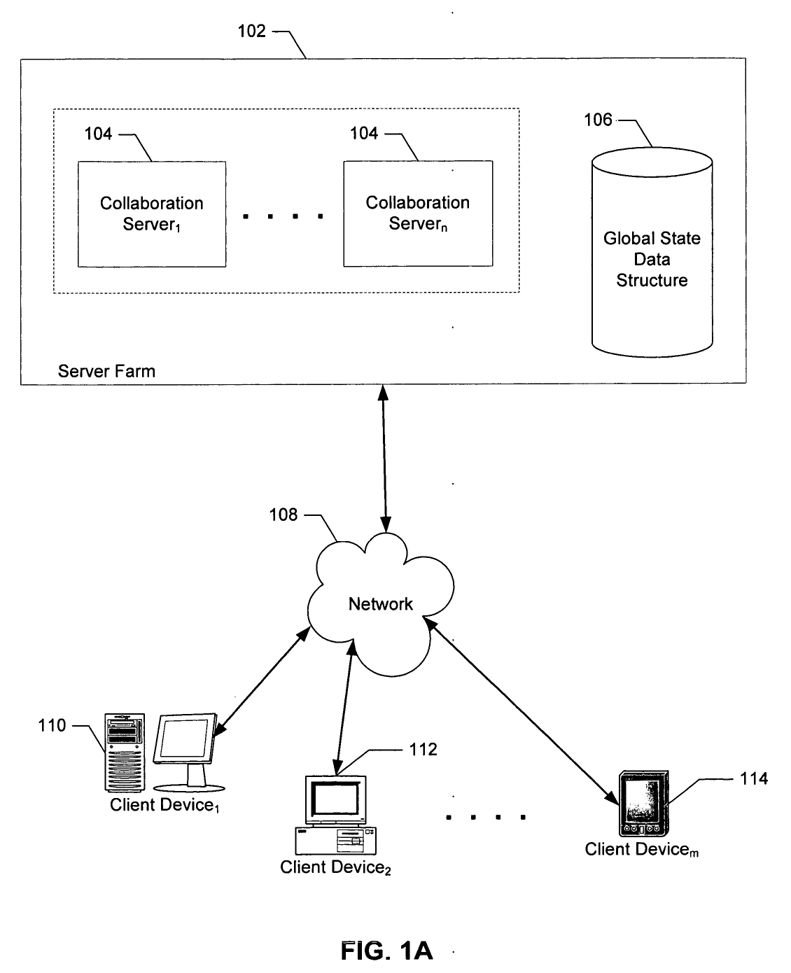

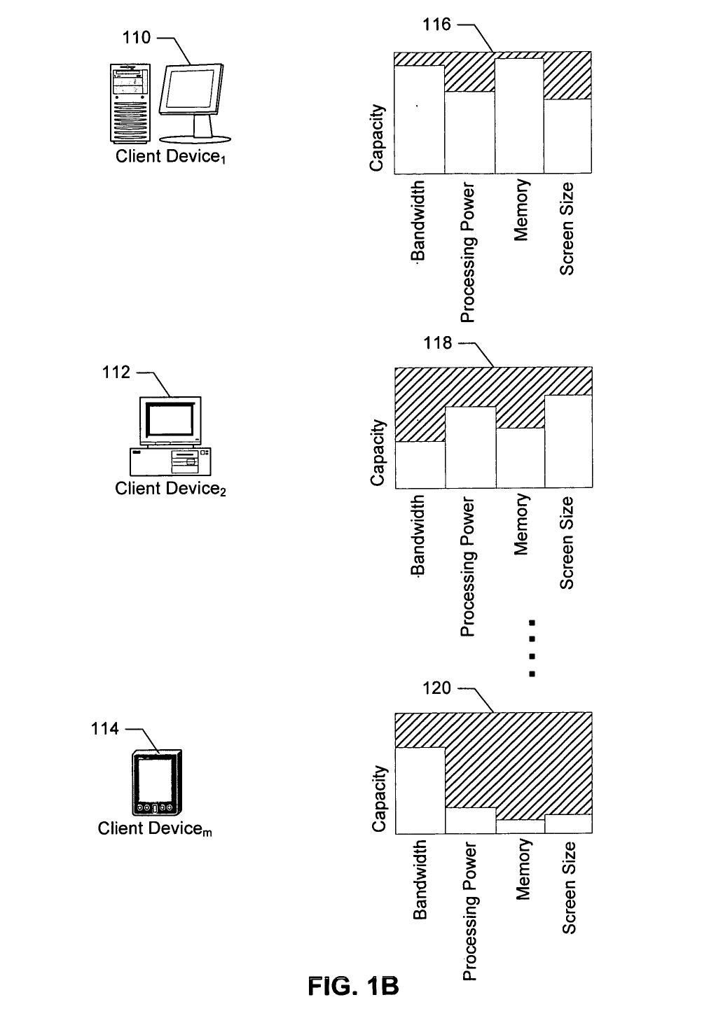

FIG. 1A is a block diagram showing three devices with differing operational characteristics participating in a collaborative environment using one embodiment of the present invention. In this example, the collaborative environment executes on a server farm 102 which in turn exchanges data with client device₁ 110, client device₂ 112 through client deviceₘ 114 over network 108. In one implementation, server farm 102 can be a group of one or more server computers. Alternatively, it can be any collection of one or more computers with the appropriate network, computing, computing, rendering and file storage capabilities.

In this example, server farm 102 contains a set of n collaboration servers 104 and a global state data structure 106. Global state data structure 106 is a database with data describing the current state of the collaborative environment elements for each client. The collaborative environments that are currently available range from multi-user game and video conferencing environments to e-commerce applications, collaborative environment for managing rich media (i.e., managing, browsing and sharing media in an environment) and collaborative work environments. However, when new collaborative environments are created, they would be interoperable with the present invention. In accordance with the present invention, the collaboration servers in server farm 102 control the rendering of environment elements depending on the operational characteristics of the different clients and then transmit compressed images to client devices 110, 112 and 114. Each of the Client Devices 110, 112, and 114 download a small software viewer to interact with and visualize the collaborative environment. Such a software viewer can be implemented for instance in a common cross-platform language such as Java or Visual Basic. This would lessen the programming required to ensure compatibility with the various client devices. Because the collaboration servers contain much of the complexity of the collaborative environment, the viewer can occupy a small area of memory or storage.

Maintaining a single version of the collaborative environment state in global state data structure 106 obviates the need for every client device to download its own local copy of the entire data set. This aspect of the invention provides a number of beneficial features. First, clients will not lose synchronization with the collaborative environment if there is network congestion or other processing anomalies. It also handles dynamically changing data efficiently without burdening each client with a large download of the updated data. Further, a client device can readily change other environment elements (e.g. modify bandwidth capabilities, switch display size, join or leave the collaborative environment) without significant disruption to the other client devices.

Benefits of global state data structure 106 are especially important in dynamically changing databases or environments. In these environments, it is important for the user experience that the state of environment elements be consistent and in constant synchronization on each client device. For instance, a collaboration server in a multi-user game collects updates concerning player position and implement/weapon status in centrally located global state data structure 106 and then renders an appropriate view for each client device.

Server farm 102 handles the load of rendering and distributing the appropriate view to every client according to the client's capabilities. Clients with weaker rendering abilities need not download the entire collaborative environment global state database and render it locally, which may be impossible or infeasible. The approach also ensures that the weakest clients do not slow down other clients' interaction with the environment. Accordingly, server farm 102 is not only adapted to respond quickly to rendering requests from the set of clients but can readily be scaled up or down to handle a larger or smaller number of clients and their requests.

In some image compression schemes, the compression for the rendered frames is roughly fixed and is more or less independent of the complexity of the environment. In one embodiment of the present invention, the server farm 102 can dynamically shift more rendering to clients possessing more graphics power, bandwidth, or memory. This approach is also platform independent; one need only create multi-platform client software. Clients can easily download the software's small footprint and may be quickly added to the collaboration or even switch to a different environment.

FIG. 1B illustrates the different operational characteristics 116, 118, and 120 of client devices 110, 112 and 114 respectively from FIG. 1A. Operational characteristic 116 describes a workstation with an XGA* (1024×768) display, fast Ethernet network connection, high processing power and high memory. Operational characteristic 118 is associated with a home gaming PC with a large WUXGA (1920×1200) display, slower ISDN network connection, higher processing power and lower memory. Finally, operational characteristic 120 corresponds to a PDA with a small qVGA* (320×240) display, a fast wireless connection, and a very small processing power and memory size footprint. Each client device is provided with different types and amounts of assistance from a collaboration server designed and configured in accordance with the present invention. As will be described in further detail later herein, the collaboration servers perform different amounts of backend processing to ensure the various client devices are able to interactively engage in the collaborative environment despite their operational differences.

For example, in FIG. 1A server farm 102 uses specialized hardware and software to offload rendering tasks on the client devices depending on the operational characteristics. Dedicating certain hardware in server farm 102 to compression/decompression and other operations greatly improves the overall performance of the system and balances the different capabilities of the devices. Alternatively, the server can dynamically shift part or the entire rendering load to a given client if it can support the load otherwise performed by a collaboration server. Typically, this would occur if the client is above a certain bandwidth, memory, and rendering requirements and the client can assist in balancing the workload.

One or more collaboration servers modify the method of rendering images for each client according to their operational characteristics. For client device 110, a collaboration server may send compressed streaming video in a format such as AVI, RM, or MPEG, or in compressed formats such as JPEG, GIF, XMB, TIF, AVI, RM, MPEG, MPEG-4, H.261, H.263, ITU-T J.81, H.263+, MPEG-4 FGS, or Quick Time. By doing this, the collaboration server is able to offload the burden of rendering images to client device 110; these processing cycles are then used to assist other less powerful client devices. The smaller compressed size of the video and other images may also benefit client device 110 if the bandwidth is slower or temporarily reduced. In general, the size of the compressed images is more or less constant and independent of the complexity of the collaborative environment. This ensures that the clients will not be slowed down by sudden and drastic change in the collaborative environment. Moreover, some newer scalable compression formats enable the collaboration server to quickly discard portions of the compressed bitstream that exceed a given set of requirements. The collaboration server can also scale the content in a number of dimensions, including bitrate frame rate, resolution, quality, and color.

Rather than relying on client device to perform the computations as on client device 110 described previously, the collaboration server assumes the burden of these computations. For client device 112, the collaboration server renders descriptions of images using vector graphic primitives such as NeWS or X-Windows to efficiently compress every displayed image and to allow for fast decoding. In general, this could also be used with primitives used to generate “screen scraping” primitives that capture bitmaps directly from display drivers and related buffers. This allows the collaboration server to squeeze rich images through client device 112's low-bandwidth network connection for efficient decoding and display by client device 112's powerful processor. Alternatively, video could be transmitted using interframe coding schemes to exploit temporal coherence and perform more efficient compression.

Finally, the collaboration server renders low-resolution compressed digital images for the qVGA screen on client device 114. These lower resolution images provide images of the collaborative environment albeit at a lower quality or resolution than other devices operating in the environment. The collaboration server takes advantage of the high bandwidth wireless network connection to client device 114 while not taxing the device's lower resolution, smaller memory and computational power. For example, a user would view lower resolution images in a game on client device 114 yet would still be able to participate with other participants having higher resolution screens and more powerful processors. Alternatively, users with heterogeneous clients can collaboratively design and author content using embodiments of the present invention. Each user could modify a lower resolution version and the collaboration server could automatically modify the final higher resolution result to reflect each change.

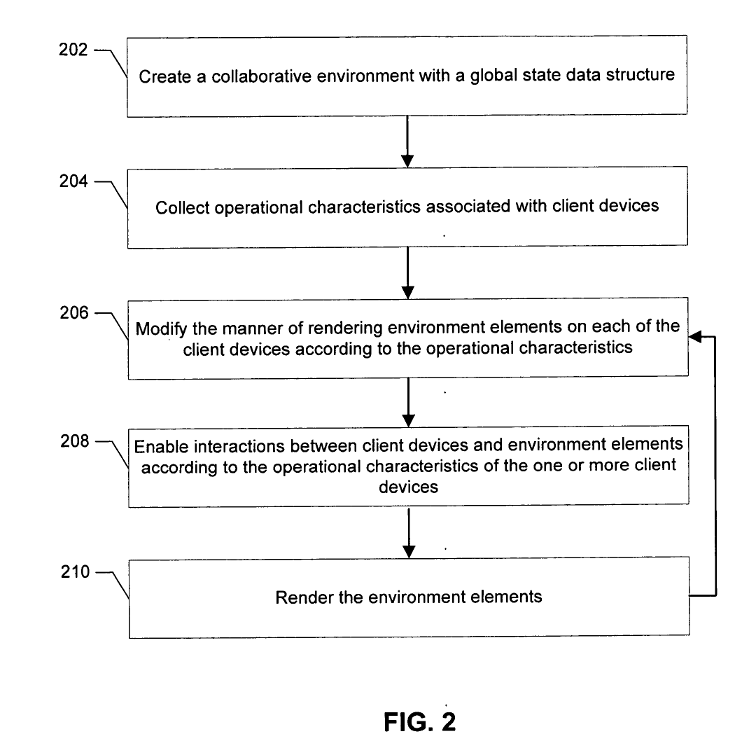

FIG. 2 is a flowchart showing the operations associated with the controlling of a collaborative computing environment in accordance with one embodiment of the present invention. These operations include: creating a collaborative environment with a global state data structure (202); collecting operational characteristics associated with client devices (204); modifying the manner of rendering environment elements on each of the client devices according to the operational characteristics (206); enabling interactions between client devices and environment elements (208); and rendering the environment elements (210).

The controlling operation initially creates a collaborative environment with a global state data structure (202). The set of environment elements maintained in the global state data structure depends on the collaborative environment. For instance, a multi-user combat simulation might contain such elements as player locations, player weapon states, and bullet trajectories. A virtual reality system would contain simulated physical objects having shape, weight and location. An e-commerce collaborative environment would have inventory, purchase event, and sale event elements. A collaborative work environment might have documents and files whose state would describe their current contents and the identity of the person editing them. The global state data structure also includes information regarding the scalability dimensions of the content used in the collaborative environment. This enables each client to specify how best to accommodate its operational characteristics.

Next, the control operation collects operational characteristics associated with client devices (204). There are a variety of operational characteristics that might be collected about the client devices. These include communication bandwidth capacity; processing power; display size and characteristics; audio output options; memory size; rendering capabilities; and input mechanism. For example, the collaboration server can accept input from a PDA via a touch screen and from a gaming machine via a joystick.

The modification operation then modifies the manner of rendering environment elements on each of the client devices according to the operational characteristics collected (206). The collaboration server modifies the manner of rendering environment elements for each client device according to both the operational characteristics of the client devices and the nature of the collaborative environment. For example, a collaboration server may compress images for one client device having a slower communication connection and may increase the number of images transmitted to another client device receiving images over a much faster connection. Other variations in rendering may include performing computational operations on the collaboration server for client devices having lower processing or computational power. The collaboration server may also conserve transmission bandwidth by returning only the pertinent portion of the compressed scalable bitstream.

The embodiment then enables interactions between client devices and environment elements according to the operational characteristics of the one or more client devices (208). The collaboration server optimizes these interactions between client devices and environment elements based upon the collective configuration of client devices in the collaborative environment. These modifications and optimizations allow one or more heterogeneous client devices to interactively provide input to the collaborative environment and modify the state of the various environment elements. For example, pushing a joystick forward on a client device causes the position state of a virtual player to move forward in the collaborative environment and be detected by other client devices. The collaboration servers facilitate rendering the environment elements previously described (210) and these aforementioned operations repeat for the duration of the collaborative environment session.

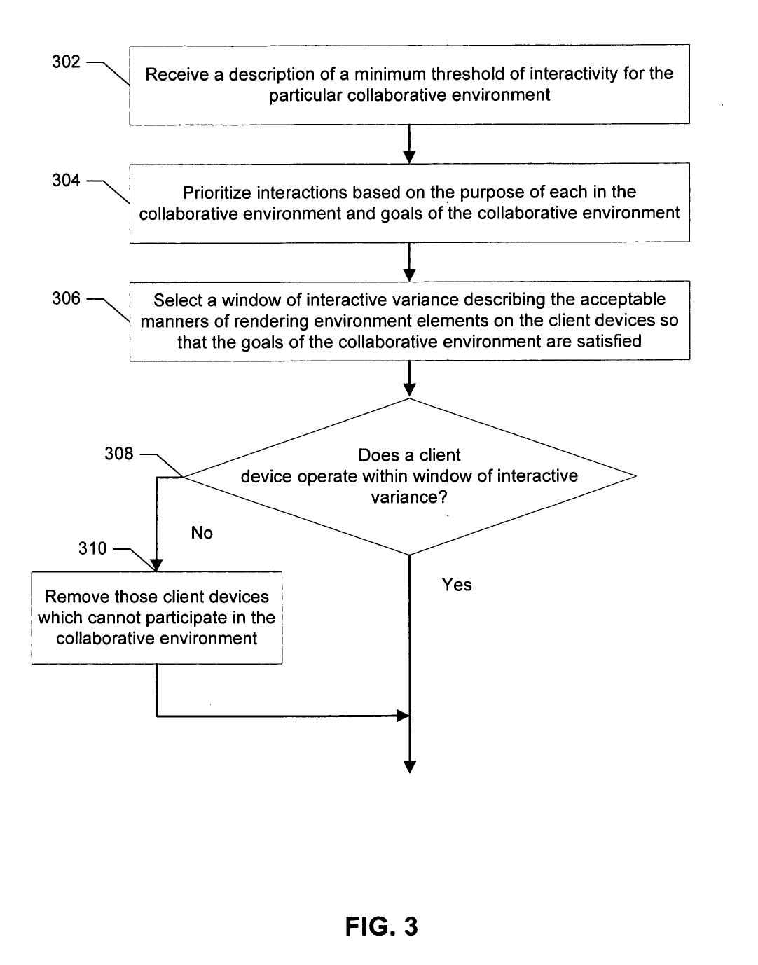

FIG. 3 is a flowchart of the operations for modifying the rendering of environment elements in accordance with one embodiment of the present invention. The operations include: receiving a description of a minimum threshold of interactivity for the particular collaborative environment (302); prioritizing interactions based on the purpose of each in the collaborative environment and goals of the collaborative environment (304); selecting a window of interactive variance describing the acceptable manners of rendering environment elements on the client devices so that the goals of the collaborative environment are satisfied (306); determining whether each client device can operate within the window of interactive variance (308); and removing those client devices which cannot participate in the collaborative environment (310).

The received minimum threshold of interactivity (302) describes the minimum functions for a device on a particular interactive environment. For instance, in a multi-player combat game, each client device might be required to render images at a frame rate of at least 15 frames per second and with sufficient detail to distinguish friend from foe. If the collaboration server is transmitting the frames to the client devices as a compressed scalable bitstream, then the minimum threshold might also describe minimum color requirements, resolution, and required detail for the rendered image.

The prioritizing of interactions (304) allows the collaborative server to further optimize the experience of users of all client devices. In the case of a combat game, the collaborative server might apply a high priority to interactions such as weapon and view interactions, and apply a relatively lower priority to speech interactions between players and rendering the background environment. Higher priority events are considered important to maintaining the level of interactivity of the application and therefore processed more readily than lower priority events and events not considered important to the overall interactivity or other function in the application.

The window of interactive variance (306) is computed by the collaborative server based on both the minimum threshold of interactivity and the prioritized interactions. The computation also takes into account the operational characteristics of the various client devices. In the case of an interactive environment involving video conferences, the window of interactive variance might exclude those devices which cannot engage in two-way audio with a maximum tolerable latency of 100 milliseconds, and include a range of other interactivity including text-based messaging or chat, exchange of documents and transmitting streaming video. The collaborative server may or may not be able to optimize the method of rendering and a particular device may not be able to participate in the interactive environment.

The collaborative server determines whether each client can operate within the window of interactive variance (308) and then removes those that cannot participate in the collaborative environment on that basis (310). This is important for a variety of reasons. First, it ensures that the user does not have a disappointing experience if their particular device characteristics do not facilitate interactive participation. For instance, in an e-commerce collaborative environment the failure to receive real-time updates on prices and transactions might prove quite expensive. Second, it also ensures that the inadequate operational characteristics of one user do not impair the experience of all users through delayed interaction with an application or environment. Third, it ensures that the resources allocated for rendering environment elements in a particular interactive environment by a collaborative server are not exceeded. Additionally, it can provide alternative types of interaction for client devices that fall beneath a particular threshold. For instance, those which cannot receive audio might receive closed captions instead. The collaboration server might also prioritize the rendering of environment elements for client devices based on account type; premier members might receive higher quality rendering.

Referring again to the collaborative combat game environment example, a high priority may be placed on the frame rate and interaction speed with weapons and objects, and relatively lower priority would be placed on sound or color. A priority function can determine how to scale and prioritize the various interactive aspects of the environment. Those devices that failed to reach the minimum threshold of interactive variance based on their frame rate or network connection would be excluded from the environment. Of course, while the above operations appear to refer to software implementations, these operations can also be implemented as both software, hardware and combinations thereof as noted in further detail later herein. Moreover, the nature of the priority function is application and content dependent.

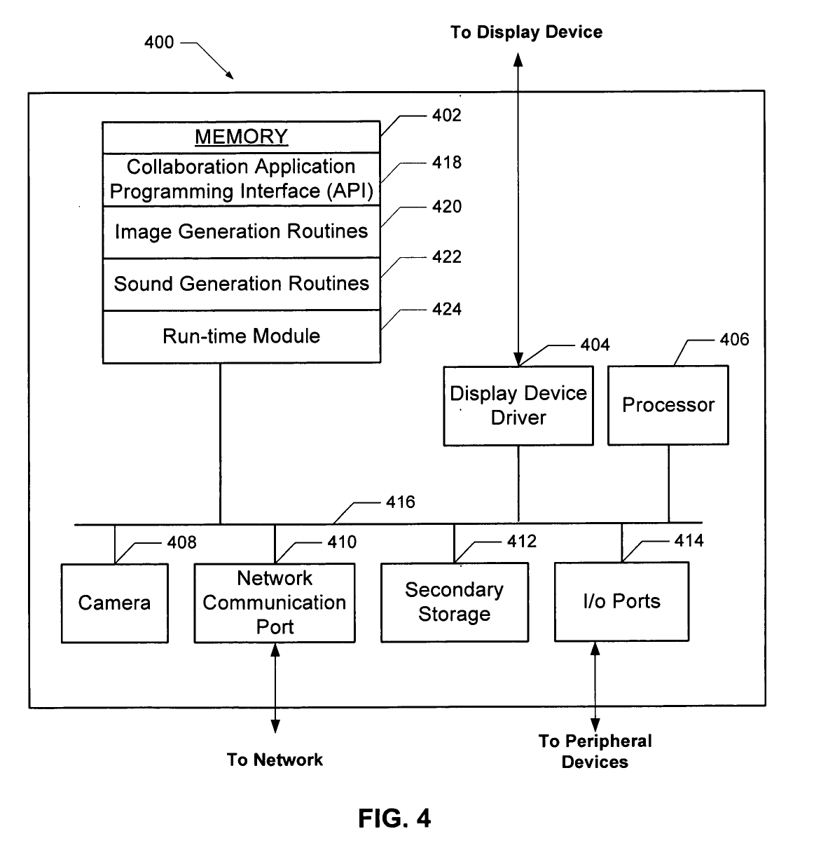

FIG. 4 is a block diagram of a system 400 used in one implementation. System 400 includes a memory 402 to hold executing programs (typically random access memory (RAM) or read-only memory (ROM) such as a flash ROM), a display device driver 404 capable of interfacing and driving a display device or output device, a processor 406, a program memory 402 for holding drivers or other frequently used programs, a camera 408, a network communication port 410 for data communication, a secondary storage 412 with a secondary storage controller and input/output (I/O) ports and controller 414 operatively coupled together over an interconnect 416. System 400 can be preprogrammed, in ROM, for example, using field-programmable gate array (FPGA) technology or it can be programmed (and reprogrammed) by loading a program from another source (for example, from a floppy disk, a CD-ROM, or another computer). Also, system 400 can be implemented using customized application specific integrated circuits (ASICs).

In one implementation, memory 402 includes a collaboration application program interface (API) 418, image generation routines 420, sound generation routines 422, and a run-time module 424 that manages system resources used when processing one or more of the above components on system 400.

Collaboration application program interface (API) 418 is a set of routines enabling interactive collaborative environments to make use of the enhancements made possible by the current invention. As is the case with APIs for other platforms and programs, this frees the application designer to concentrate on the logic and appearance of the application in the context of an interactive environment. In turn, the present embodiment contains the complexity and detail required to optimize interactions among the various heterogeneous hardware devices. For instance, when installed on a collaboration server, collaboration API 418 may include a library of routines for: modifying the method of rendering of environment elements; prioritizing the elements based on the parameters passed to collaboration API 418 by the collaborative environment; and passing the data for rendering the environment elements to dedicated routines and hardware. This frees the designer of the collaborative environment to concentrate on the graphics and logic of his or her program. The API may also include the appropriate mechanisms for handling different content formats, such as scalable compression schemes.

When running on a collaboration server, image generation routines 420 receive descriptions of graphical environment elements, and render these elements for each client device according to the device's operational characteristics. When running on a client device, the routines receive the images as rendered by the collaboration server and take whatever steps are necessary to finally display these images on the client device.

Likewise, sound generation routines 422, when running on a collaboration server, receive descriptions of sound environment elements, and render these elements for each client device according to the device's operational characteristics. When running on a client device, the routines receive the images as rendered by the collaboration server and take whatever steps are necessary to finally make these sounds audible via the client device.

Run-time module 424 manages the system resources of either a client device or a collaborative server. In the case of the collaborative server, the run-time module performs such functions as swapping data between RAM and permanent storage, balancing the load on various hardware components, and interfacing between the hardware and software components. In a client device, the run-time module creates a common platform on which the collaborative environment can execute.

As illustrated, these various modules of the present invention appear in a single computer system, camera, projector, set-top box, or computer based printer device. However, alternate implementations could also distribute these components in one or more different computers, host devices or printer devices to accommodate for processing demand, scalability, high-availability and other design constraints. In a peer-to-peer implementation, each host and peripheral or printer device includes each component to implement the present invention. An alternate implementation described in further detail previously, implements one or more components of the present invention with the host as a master device and the peripheral or printer device as a slave device.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

* XGA is a registered trademark of International Business Machines Corporation. VGA is a registered trademark of Microsoft Corporation. MPEG is a registered trademark of the Motion Picture Experts Group, Inc. Bluetooth is a registered trademark of Bluetooth SIG, Inc. Macromedia Flash is a registered trademark of Macromedia, Inc. FireWire is a registered trademark of Apple Computer, Inc. Real Media is a registered trademark of Real Networks. Inc.

1. A method of controlling a collaborative computing environment comprising:
creating a collaborative environment with a global state data structure that maintains the state of one or more environment elements of the collaborative environment;
collecting operational characteristics associated with one or more client devices;
modifying the manner of rendering environment elements on each of the one or more client devices according to the operational characteristics of the one or more client devices; and
enabling interactions between client devices and environment elements according to the environment elements' current state in the global state data structure.

2. The method of claim 1, wherein the collaborative environment is selected from a set of collaborative environments including: a multi-user game collaborative environment; an e-commerce collaborative environment; a collaborative environment for conferencing; a collaborative environment for managing rich media; and a collaborative work environment.

3. The method of claim 1, wherein the environment elements comprise one or more environment elements selected from a set including: simulated physical object environment elements, surface feature environment elements, sound environment elements, purchase and sale record environment elements, financial data environment elements, rich media elements, and document environment elements.

4. The method of claim 1, wherein the one or more client devices comprise a plurality of client devices and are heterogeneous in their operational characteristics.

5. The method of claim 1, wherein the one or more client devices are selected from a set of devices including: a PDA, a Pocket PC, a laptop computer, a desktop computer, a workstation computer, a cell phone, a tablet PC, and a game device.

6. The method of claim 1, wherein the collecting further comprises collecting operational characteristics of communication bandwidth capacity associated with the one or more client devices.

7. The method of claim 1, wherein the collecting further comprises collecting operational characteristics of processing power associated with the one or more client devices.

8. The method of claim 1, wherein the collecting further comprises collecting display operational characteristics associated with the one or more client devices.

9. The method of claim 1, wherein the collecting further comprises collecting audio output operational characteristics associated with the one or more client devices.

10. The method of claim 1, wherein the collecting further comprises gathering memory operational characteristics associated with the one or more client devices.

11. The method of claim 1, wherein the collecting further comprises gathering input mechanism operational characteristics associated with the one or more client devices.

12. The method of claim 1, wherein the global state is maintained on a centralized server.

13. The method of claim 1, wherein the modifying further comprises the steps of:
prioritizing the interactions based on the purpose of each in the collaborative environment and one or more goals of the collaborative environment; and
selecting a window of interactive variance describing the acceptable manners of rendering environment elements on the client devices based on the priorities of interactions with those elements.

14. The method of claim 13, wherein the interactions comprise interactions from a set including: interactions with weapon environment elements in a multi-user game collaborative environment, interactions with documents in a collaborative work environment, interactions with purchase and sale records in an e-commerce collaborative environment, interactions with live audio and live video environment elements in a collaborative environment for conferencing, interactions with files in a collaborative authoring environment, interactions with a collaborative environment for managing rich media, and interactions with designs and specifications in an interactive design environment.

15. The method of claim 13, wherein the selecting further comprises receiving a description of a minimum threshold of interactions required for the window of interactive variance for the particular collaborative environment.

16. The method of claim 15, wherein the selecting further comprises the steps of:
determining whether one or more of the client devices can operate within the window of interactive variance based on their operational characteristics; and
removing those one or more client devices which cannot participate in the collaborative environment based on their operational characteristics.

17. The method of claim 1, further comprising rendering the environment elements.

18. The method of claim 17, wherein the rendering further comprises creating digital images in a compressed format for transmission to the one or more client devices.

19. The method of claim 18, wherein the compressed format is selected from a set including: JPEG, GIF, XMB, TIF, AVI, RM, MPEG, and Quick Time.

20. The method of claim 18, wherein the compressed format is a format of scalable video compression selected from a set of scalable video compression formats including: MPEG-4, H.261, H.263, ITU-T J.81, H.263+, and MPEG-4 FGS.

21. The method of claim 17, wherein the rendering further comprises creating digital images using graphic primitives for transmission to the one or more client devices.

22. The method of claim 21, wherein the graphic primitives are selected from a set of primitives including: NeWS, X-Windows, Sun Rasterfile, HTML, VRML, OpenGL, DirectX, and Flash.

23. The method of claim 17, further comprising dynamically adjusting the operational characteristics for a client device.

24. The method of claim 1, wherein the collaborative environment and global state data structure are located on one or more servers.

25. A system for controlling a collaborative computing environment comprising:
one or more servers;
one or more client devices;
a network connecting the server(s) with the client device(s);
a collaborative environment with a global state data structure that maintains the state of one or more environment elements of the collaborative environment;
a module for collecting operational characteristics that describe the one or more client devices;
a module for modifying the manner of rendering the environment elements for the one or more client devices based on their operational characteristics; and
a module for enabling interactions between client devices and environment elements according to the environment elements' current state in the global state data structure.

26. The system of claim 25, wherein the one or more servers are organized in a server farm.

27. The system of claim 25, wherein the one or more client devices include one or more devices from a set of devices including: a PDA, a Pocket PC, a laptop computer, a desktop computer, a workstation computer, a cell phone, a tablet PC, and a game device.

28. The system of claim 25, wherein the network connecting the server with the client devices further comprises one or more systems selected from a set of technologies including: 802.11, Ethernet, powerline, analog modem, BlueTooth, infra-red, PCI, USB, FireWire, GSM, and TDMA.

29. The system of claim 25, wherein the collaborative environment is selected from a set including: a multi-user game collaborative environment; an e-commerce collaborative environment; a collaborative environment for conferencing, a collaborative environment for managing rich media and a collaborative work environment.

30. The system of claim 25, wherein the module for modifying further comprises:
a routine for prioritizing the interactions based on the purpose of each in the collaborative environment and one or more goals of the collaborative environment; and
a routine for selecting a window of interactive variance describing the acceptable manners of rendering environment elements on the client devices so that the goals of the collaborative environment are satisfied.

31. The system of claim 30, wherein the interactions comprise interactions from a set including: interactions with weapon environment elements in a multi-user game collaborative environment, interactions with documents in a collaborative work environment, interactions with purchase and sale records in an e-commerce collaborative environment, interactions with live audio and live video environment elements in a collaborative environment for conferencing, interactions with a collaborative environment for managing rich media, and interactions with documents in a collaborative work environment.

32. The system of claim 30, wherein the routine for selecting further comprises receiving a description of a minimum threshold of interactions required for the window of interactive variance for the particular collaborative environment.

33. The system of claim 31, wherein the routine for selecting further comprises:
a routine for determining whether one or more of the client devices can operate within the window of interactive variance based on their operational characteristics; and
a routine for removing those one or more client devices which cannot participate in the collaborative environment based on their operational characteristics.

34. The system of claim 25, further comprising a module for rendering environment elements on the client devices.

35. The system of claim 34, wherein the module for rendering environment elements generates graphic primitives for transmission to the client device.

36. The system of claim 35, wherein the module for rendering environment elements further comprises a system for generating graphics primitives selected from a set of graphic primitives including: NeWS, X-Windows, Sun Rasterfile, HTML, VRML, OpenGL, DirectX, and Flash.

37. The system of claim 34, wherein the module for rendering environment elements further comprises a system for generating compressed images.

38. The system of claim 37, wherein the system for generating compressed images further comprises a system for generating images of a format selected from a set including: JPEG, GIF, XMB, TIF, AVI, RM, MPEG, MPEG-4, H.261, H.263, ITU-T J.81, H.263+, MPEG-4 FGS, and Quick Time.

39. An apparatus for controlling a collaborative computing environment comprising:
means for creating a collaborative environment with a global state data structure that maintains the state of one or more environment elements of the collaborative environment;
means for collecting operational characteristics associated with one or more client devices;
means for modifying the manner of rendering environment elements on each of the one or more client devices according to the operational characteristics of the one or more client devices; and
means for enabling interactions between client devices and environment elements according to the environment elements' current state in the global state data structure.

40. A computer program product for controlling a collaborative computing environment, comprising instructions operable to cause a programmable processor to:
create a collaborative environment with a global state data structure that maintains the state of one or more environment elements of the collaborative environment;
collect operational characteristics associated with one or more client devices;
modify the manner of rendering environment elements on each of the one or more client devices according to the operational characteristics of the one or more client devices; and
enable interactions between client devices and environment elements according to the environment elements' current state in the global state data structure.
